(19) United States
(12) Patent Application Publication
(10) Pub. No.: US 2023/0039496 A1
(43) Pub. Date: Feb. 9, 2023

(54) QUESTION-AND-ANSWER PROCESSING METHOD, ELECTRONIC DEVICE AND COMPUTER READABLE MEDIUM

(71) Applicant: BOE TECHNOLOGY GROUP CO., LTD., Beijing (CN)

(72) Inventor: Bingqian WANG, Beijing (CN)

(21) Appl. No.: 17/789,620

(22) PCT Filed: Aug. 5, 2021
(86) PCT No.: PCT/CN2021/110785

§ 371 Date: Jun. 28, 2022

(30) Foreign Application Priority Data
Sep. 27, 2020 (CN) 202011036463.5

(51) Int. Cl. G06F 40/30; G06N 5/02; G06F 16/332; G06F 40/279

(52) U.S. Cl. CPC G06F 40/30; G06N 5/02; G06F 16/3329; G06F 40/279

(57) ABSTRACT

The embodiment of the present disclosure provides a question-and-answer processing method, including: acquiring a to-be-answered question; determining standard questions meeting a preset condition as a plurality of candidate standard questions, from a plurality of preset standard questions, according to a text similarity with the to-be-answered question, based on a text statistical algorithm; determining, a candidate standard question with the highest semantic similarity with the to-be-answered question as a matching standard question, from the plurality of candidate standard questions, based on a deep text matching algorithm; and determining an answer to the to-be-answered question at least according to the matching standard question. The embodiment of the present disclosure also provides an electronic device and a computer readable medium.

### TECHNICAL FIELD

The present disclosure relates to the field of automatic question-and-answer technology, in particular to a question-and-answer processing method, an electronic device and a computer readable medium.

### BACKGROUND

Automatic question-and-answer is a technique for automatically answering questions posed by a user based on a predetermined database (e.g., a knowledge mapping).

To implement automatic question-and-answer, an “intention” matched with a question posed by the user may be determined, i.e., “automatic question-and-answer in a matching manner”.

However, the existing algorithm for matching the question with the “intention” has a high error rate and easily generates semantic deviation; or has large computation amount, low efficiency and low speed, and is difficult to be practical in a high concurrency scene.

### SUMMARY

An embodiment of the present disclosure provides a question-and-answer processing method, including: acquiring a to-be-answered question; determining standard questions meeting a preset condition as a plurality of candidate standard questions, from a plurality of preset standard questions, according to a text similarity with the to-be-answered question, based on a text statistical algorithm; determining, a candidate standard question with the highest semantic similarity with the to-be-answered question as a matching standard question, from the plurality of candidate standard questions, based on a deep text matching algorithm; and determining an answer to the to-be-answered question at least according to the matching standard question.

An embodiment of the present disclosure further provides an electronic device, including: one or more processors; a memory on which one or more programs are stored, when executed by the one or more processors, the one or more programs cause the one or more processors to implement the question-and-answer processing method of any one of the above embodiments; and one or more I/O interfaces coupled between the processor and the memory and configured to realize an information interaction between the processor and the memory.

An embodiment of the present disclosure further provides a computer-readable medium, on which a computer program is stored, wherein the computer program is executed by a processor to implement the question-and-answer processing method of any one of the above embodiments.

According to the embodiment of the present disclosure, firstly, candidate standard questions which may be matched with a to-be-answered question is comprehensively recalled by using a high-efficiency text statistical algorithm, so as to realize a high recall ratio; then, a matching standard question which is accurately matched with the to-be-answered question is selected from the candidate standard questions by using a high-accuracy deep text matching algorithm, so as to realize a high precision ratio. That is, the embodiment of the present disclosure may simultaneously realize the high recall ratio and the high precision ratio.

### BRIEF DESCRIPTION OF DRAWINGS

The accompanying drawings, which are provided for further understanding of embodiments of the present disclosure and constitute a part of this specification, are for explaining the present disclosure together with the embodiments of the present disclosure, but are not intended to limit the present disclosure. The above and other features and advantages will become more apparent to ordinary skill in the art by describing in detail exemplary embodiments thereof with reference to the drawings. In the drawings:

FIG. 1 is a schematic diagram of a partial content of a knowledge mapping;

FIG. 2 is a flow chart of a question-and-answer processing method provided by an embodiment of the present disclosure;

FIG. 3 is a flow chart of another question-and-answer processing method provided by an embodiment of the present disclosure;

FIG. 4 is a schematic diagram of a logic process of another question-and-answer processing method provided by an embodiment of the present disclosure;

FIG. 5 is a schematic diagram of a logical structure of a deep learning text matching model used in another question-and-answer processing method provided by the embodiment of the present disclosure;

FIG. 6 is a block diagram of an electronic device according to an embodiment of the present disclosure; and

FIG. 7 is a block diagram of a computer-readable medium according to an embodiment of the present disclosure.

### DETAIL DESCRIPTION OF EMBODIMENTS

In order to enable one of ordinary skill in the art to better understand the technical solutions of the embodiments of the present disclosure, a question-and-answer processing method, an electronic device and a computer readable medium of embodiments of the present disclosure will be described in further detail with reference to the accompanying drawings.

The embodiments of the present disclosure will be described more fully hereinafter with reference to the accompanying drawings, but the embodiments shown may be embodied in different forms and should not be construed as limited to the embodiments set forth herein. Rather, these embodiments are provided so that the present disclosure will be thorough and complete, and will fully convey the scope of the present disclosure to one ordinary skill in the art.

Embodiments of the present disclosure may be described with reference to plan and/or cross-sectional views by way of idealized schematic diagrams of the present disclosure. Accordingly, the example illustrations may be modified in accordance with manufacturing techniques and/or tolerances.

Embodiments of the present disclosure and features of the embodiments may be combined with each other in case of no conflict.

The terms used herein are for the purpose of describing particular embodiments only and are not intended to limit the present disclosure. As used in the present disclosure, the term “and/or” includes any and all combinations of one or more of the associated listed items. As used herein, the singular forms “a”, “an” and “the” are intended to include a plural form as well, unless the context clearly indicates otherwise. As used herein, the terms “including” and/or “comprising,” specify the presence of stated features, integers, steps, operations, elements, and/or components, but do not exclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It should be further understood that terms, such as those defined in commonly used dictionaries, should be interpreted as having a meaning that is consistent with their meaning in the context of the relevant art and the present disclosure, and should not be interpreted in an idealized or overly formal sense unless expressly so defined herein.

The disclosed embodiments are not limited to the embodiments shown in the drawings, but include modifications of configurations formed based on a manufacturing process. Thus, areas illustrated in the drawings have schematic properties, and shapes of the areas shown in the drawings illustrate specific shapes of the areas of elements, but are not intended to be restrictive.

In some related art, a question posed by a user may be automatically answered by “automatic question-and-answer in a matching manner (hereinafter, matching automatic question-and-answer)”, i.e., an answer to the question posed by the user is automatically found.

The matching automatic question-and-answer may be implemented based on a preset knowledge mapping and standard questions.

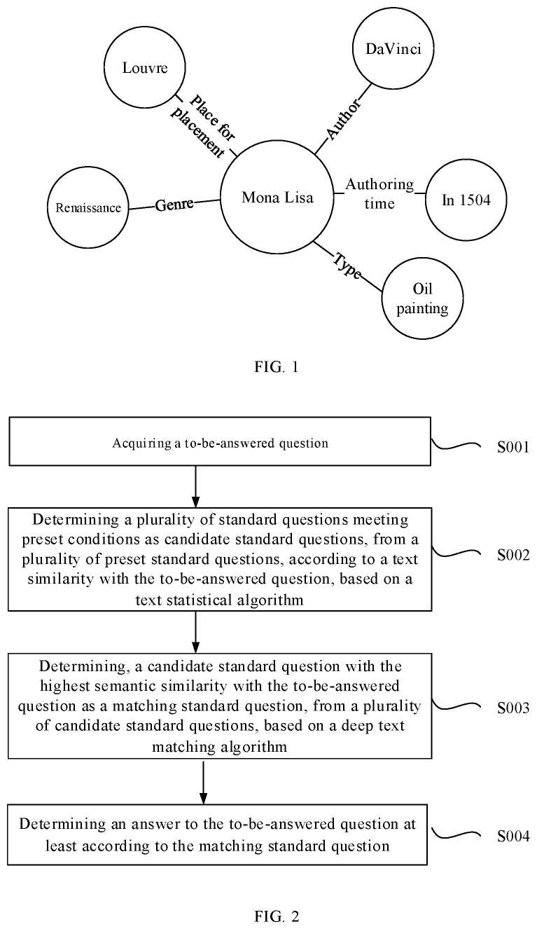

The knowledge mapping (knowledge base) is a collection of data (i.e., a database) representing an entity and values of its attributes; in the knowledge mapping, entities are used as nodes, and the entities and the values of the attributes corresponding to the entities are connected to each other through lines, thereby forming a structured and network-like database. For example, referring to FIG. 1, for an entity “Mona Lisa”, a value of its “author” attribute is “DaVinci (which is also another entity),” and a value of its “authoring time” attribute is “1504”, etc.

The entity is also referred to as “knowledge” or “concept” and refers to a physical or abstract definition that exists or has ever existed, such as person, object, substance, structure, product, building, art, place, country, organization, event, technology, theorem, theory, or the like.

Each “question (query)” actually corresponds to a certain “intention”, i.e., the “intention” is the essential meaning that the question is intended to convey. For example, an “intention” of a question “who is the author of Mona Lisa” is to ask a value of an “author” attribute of the entity “Mona Lisa”.

For a certain “intention”, a code corresponding to the “intention” may be configured in advance, and when the code is run, a content matched with the “intention” may be obtained from the knowledge mapping as an answer. For example, for the “intention” to ask the value of the “author” attribute of the entity “Mona Lisa”, it may be retrieved from the knowledge mapping that the value of the “author” attribute of the entity “Mona Lisa” is “DaVinci”, so that “DaVinci” is the answer.

For the same “intention”, different users may “pose a question” in different ways, or each “intention” corresponds to many different “ways for posing a question”. For this reason, for each “intention”, a plurality of different “ways for posing a question” may be set in advance, or “standard questions” may be set. For example, for an “intention” of asking a “nationality” attribute of the entity “DaVinci”, the corresponding standard questions may exemplarily include: what is the nationality of DaVinci; where is DaVinci from; who knows where DaVinci is born; who can tell me where DaVinci comes from.

The above standard questions may also be in the form of a “template”, that is, an “entity” thereof may not be specific entity content, but be a “type label” corresponding to a type of the entity; the type of the entity refers to a “characteristic” or a “classification” of the entity in some aspect. For example, DaVinci is a historical personage, and the entity “DaVinci” belongs to the type of “person”.

The type label may be represented by a specific character or a combination of characters, preferably an uncommon character or a combination of characters, which may be a number, a letter, a symbol, a Chinese character. For example, the “type label” of the “person” type may be represented by letters “RW”, or by the Chinese character “ [symbol] ”. Thus, the form of each of the above standard questions may also be converted into: what is the nationality of RW; or what is the nationality of [symbol] ; where is RW from; or where is [symbol] from; who knows where RW is born; or who knows where [symbol] is born; Who can tell me where RW comes from; or who can tell me where [symbol] comes from.

Therefore, as long as the question posed by the user is determined to be most “similar to (or matched with)” a specific standard question, which is equivalent to the question posed by the user being determined to be same as the “intention” of the standard question, the answer of the question posed by the user may be found out from the knowledge mapping according to the “intention” of the standard question. For example, code corresponding to the “intention” of the above standard question is run to find the answer to the question posed by the user from the knowledge mapping.

Obviously, if the question posed by the user is exactly the same as a certain standard question, the question posed by the user and the standard question are obviously matched with each other. However, an “intention” may correspond to many possible ways for posing a question, and the standard questions cannot be exhaustive, so that the question posed by the user is likely not identical to any one of all standard questions. For example, for the “intention” of asking the “nationality” attribute of the entity “DaVinci”, the question posed by the user may be a dialect of Sichuan province in China, such as “what place DaVinci is born” in form of dialect of Sichuan province, which is different from all standard questions.

Therefore, in many cases, the question posed by the user needs to be analyzed against the standard questions to determine the standard question with which the question posed by the user actually matches.

For example, a representation-based model may be used to implement matching of a user question (the question posed by the user) with the standard question. Specifically, a text (including the question posed by the user and the standard question) is converted into sentence vectors, and then similarity between the sentence vectors is calculated. However, the representation-based model is prone to cause “semantic deviation”, resulting in that the standard question with the “intention” really matching the question posed by the user may not be found, resulting in a matching error and failing to obtain a correct answer.

For example, an interaction-based model may also be used to implement matching of the user question with the standard question. Specifically, a cross matrix is obtained to perform matching with a finer granularity, so that the probability of the semantic deviation is low. However, the interaction-based model requires a large amount of computation, is inefficient, takes a long time to provide an answer, and is difficult to be applied in a high concurrency scene.

In a first aspect, an embodiment of the present disclosure provides an question-and-answer processing method.

The method of the embodiments of the present disclosure is used for providing answers in automatic question-and-answer with a matching manner, and is particularly implemented based on a preset knowledge mapping and preset standard questions.

Specifically, for a question posed by a user (a to-be-answered question, also referred to as a user question), in the embodiment of the present disclosure, a standard question (matching standard question) that matches with the to-be-answered question (i.e., both represents the same “intention”) may be found from a large number of preset standard questions, an answer to the to-be-answered question is obtained according to the matching standard question (or “intention” of the matching standard question), and the to-be-answered question is automatically answered; in particular, the answer to the to-be-answered question may be obtained from the preset knowledge mapping according to the matching standard question.

Referring to FIG. 2, the question-and-answer processing method according to an embodiment of the present disclosure includes Steps S001 to S004.

Step S001 includes acquiring a to-be-answered question.

A question (Query) which is posed by the user and needs to be answered is acquired as the to-be-answered question.

The specific manner of acquiring the to-be-answered question is various. For example, a content directly input by the user may be acquired as the to-be-answered question through an input device such as a keyboard and a microphone; alternatively, the to-be-answered question may be acquired from a remote location by network transmission or the like.

Step S002 includes determining a plurality of standard questions meeting preset conditions as candidate standard questions, from a plurality of preset standard questions, according to a text similarity with the to-be-answered question, based on a text statistical algorithm.

Text (or character) contents of each standard question and the to-be-answered question is analyzed by using the text statistical algorithm, thereby obtaining the similarity (namely, the text similarity) between each standard question and the to-be-answered question with respect to the viewpoint of the text content (not the meaning represented by the text); and the plurality of standard questions are selected as the candidate standard questions for subsequent processing, according to the text similarity.

Each of the candidate standard questions selected here should be a standard question having a relatively high text similarity with the to-be-answered question, such as a standard question having the text similarity with the to-be-answered question ranked at the top, or a standard question with the text similarity exceeding a certain value.

Specifically, the text statistical algorithm here may be a text similarity algorithm.

It may be seen that the text contents of the to-be-answered question and the standard question matched with each other are not necessarily identical to each other, but have a highly similarity (text similarity) with each other. Therefore, there is a high probability that the plurality of candidate standard questions selected in this step include standard questions that match the to-be-answered question (i.e., both have a same “intention”). Of course, there may be some candidate standard questions each having “intention” different from that of the to-be-answered question, which may be solved in a subsequent process.

That is, this step may ensure that the standard question truly matched with the to-be-answered question is “recalled”, i.e., the “recall rate (recall ratio)” is high.

Compared with a deep text matching algorithm for analyzing semantics, the text statistical algorithm for calculating the statistical characteristics of the text content only needs a small amount of calculation and is efficient, so that the method may be practical even in a high concurrency scene.

Step S003 includes determining, a candidate standard question with the highest semantic similarity with the to-be-answered question as a matching standard question, from a plurality of candidate standard questions, based on a deep text matching algorithm.

The semantic similarity between the selected candidate standard questions and the to-be-answered question is further analyzed by the deep text matching algorithm, that is, which candidate standard question is closest to the to-be-answered question is analyzed from the viewpoint of the semantic (i.e., the actual meaning represented by the text), and the result is taken as the matching standard question, that is, the standard question having the “intention” same as that of the to-be-answered question.

The deep text matching algorithm determines the matching standard question according to the semantic similarity. Thus, the algorithm has a low probability of semantic deviation, and a high accuracy. In this way, the matching standard question which is really matched with the to-be-answered question may be selected in the embodiment of the present disclosure, so as to obtain an accurate answer according to the matching standard question subsequently, which improves the “accuracy (precision ratio)” of the embodiment of the present disclosure.

It may be seen that according to the embodiment of the present disclosure, the selected candidate standard questions rather than all the standard questions are processed by the deep text matching algorithm. The number of candidate standard questions is obviously much smaller than the total number of standard questions, so that the data amount processed by the deep text matching algorithm is greatly reduced, and thus the processing speed is high, and the processing may be efficiently completed even in the high concurrency scene.

Step S004 includes determining an answer to the to-be-answered question at least according to the matching standard question.

After the matching standard question is determined, that is, the “intention” of the to-be-answered question is determined, the answer to the to-be-answered question may be obtained based on the matching standard question (“intention”).

According to the embodiment of the present disclosure, firstly, candidate standard questions which may be matched with a to-be-answered question is comprehensively recalled by using a high-efficiency text statistical algorithm, so as to realize a high recall ratio; then, a matching standard question which is accurately matched with the to-be-answered question is selected from the candidate standard questions by using a high-accuracy deep text matching algorithm, so as to realize a high precision ratio. That is, the embodiment of the present disclosure may simultaneously realize the high recall ratio and the high precision ratio.

The text statistical algorithm processes a larger data amount and has a high efficiency, and the deep text matching algorithm has a relatively low efficiency but processes a less data amount (only processing candidate standard questions), so that in the embodiment of the present disclosure, the overall efficiency is high, the time consumption is less, and the method may be used for the high concurrency scene.

In some embodiments, determining an answer to the to-be-answered question at least according to the matching standard question (Step S004) includes: determining the answer to the to-be-answered question in a preset knowledge mapping at least according to the matching standard question.

As a mode of the embodiment of the present disclosure, the answer corresponding to the to-be-answered question may be found from the preset knowledge mapping according to the matching standard question (intention).

For example, a code corresponding to the matching standard question (i.e., the “intention”) may be run to derive the answer to the matching standard question, i.e., the answer to the to-be-answered question, from the knowledge mapping.

The knowledge mapping used in the embodiment of the present disclosure may be a knowledge mapping for a specific field, for example, a knowledge mapping for an art field, so that the embodiment of the present disclosure realizes the automatic question-and-answer in a “vertical field”. Alternatively, the knowledge mapping used in the embodiments of the present disclosure may also be a knowledge mapping including contents of multiple fields, so that the embodiments of the present disclosure realizes the automatic question-and-answer in an “open field”.

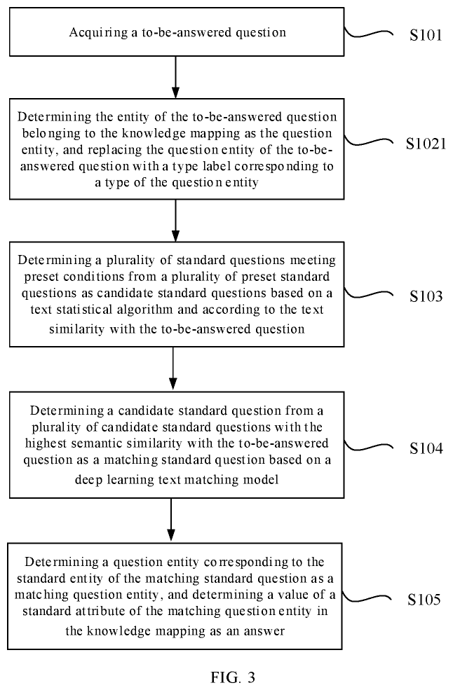

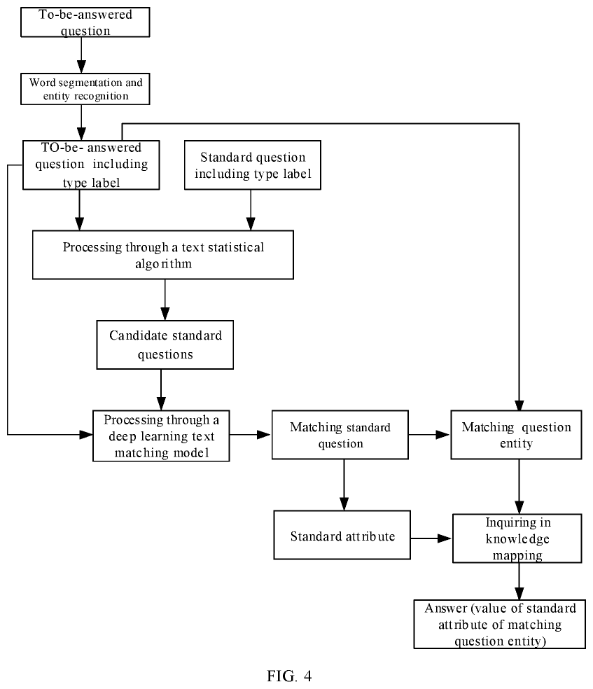

In some embodiments, referring to FIGS. 3 and 4, the question-and-answer processing method of the embodiments of the present disclosure may include the following Steps S101 to S105.

Step S101 includes acquiring a to-be-answered question.

A question (query) which is posed by the user and needs to be answered is acquired as the to-be-answered question.

The specific manner of acquiring the to-be-answered question is various. For example, a content directly input by the user may be acquired as the to-be-answered question through an input device such as a keyboard and a microphone; alternatively, the to-be-answered question may be acquired from a remote location by network transmission or the like.

For example, the to-be-answered question may be “which year the Last Supper of DaVinci was authored”.

Step S102 includes determining an entity of the to-be-answered question belonging to a knowledge mapping as a question entity.

Generally, the to-be-answered question is a question to ask about an entity, and therefore, necessarily includes the entity, so that the entity may be recognized in the to-be-answered question (i.e., perform an entity recognition) to determine the entity therein which is taken as the “question entity”.

The above “question entity” is an entity that exists in a corresponding knowledge mapping, and because the embodiments of the present disclosure are based on the knowledge mapping, it is no practical significance to recognize entities that do not exist in the knowledge mapping.

For example, for the above to-be-answered question of “which year the Last Supper of DaVinci was authored”, “DaVinci” and “the Last Supper” may each be recognized as the “question entity”.

Since the entity recognition is based on the knowledge mapping, the entity recognition may be carried out in a “remote supervision” mode. For example, an existing word segmentation tool, such as jieba word segmentation tool, may be used, and the knowledge mapping is used as a user dictionary of the word segmentation tool, so as to perform a word segmentation and the entity recognition on the to-be-answered question by using the word segmentation tool. In this way, it does not need to mark a large amount of data and does not need to train a deep learning network, so that the time and the computation amount are saved, and the method has a high efficiency and a precision and is easily to be realized.

Of course, it is also possible that the recognition of the question entity is performed by other means. For example, entity recognition may be performed by the Bi-LSTM-CRF model.

In some embodiments, determining an entity of the to-be-answered question belonging to a knowledge mapping as a question entity (S102) includes Step S1021.

Step S1021 includes determining the entity of the to-be-answered question belonging to the knowledge mapping as the question entity, and replacing the question entity of the to-be-answered question with a type label corresponding to a type of the question entity.

In the entity recognition process, in addition to recognizing “which” entities are included, a “type” of the recognized entity may be also obtained, i.e., a “property” or a “classification” of the entity in a certain respect. Therefore, in this step, the entity of the to-be-answered question may be further replaced with a corresponding type label.

For example, for the above to-be-answered question of “which year the Last Supper of DaVinci was authored”, “DaVinci” and “the Last Supper” may each be recognized as the “question entity”; furthermore, the type of the question entity “DaVinci” may be recognized as “person”, and the corresponding type label is “RW” or “ [symbol] ”; and the type of the question entity “the Last Supper” is “works”, and the corresponding type label is “ZP” or “ [symbol] ”.

Thus, the above to-be-answered question of “which year the Last Supper of DaVinci was authored” may be transformed into the following form.

Which year ZP of RW was authored; or which year [symbol] of [symbol] was authored.

Of course, it should be understood that the above division of entity types, the representation of type labels are all exemplary, and may also be in different forms. For example, the types may be divided differently, for example, the type of “DaVinci” may also be “painter”, “author”, “artist”, etc.; and the type of “the Last Supper” may also be “drawing” and the like. As another example, the type labels for “person” and “works” may be other characters or a combination of characters.

Step S103 includes determining a plurality of standard questions meeting preset conditions from a plurality of 4 preset standard questions as candidate standard questions based on a text statistical algorithm and according to the text similarity with the to-be-answered question.

The text similarity between each preset standard question and the to-be-answered question is determined based on the text statistical algorithm, and then the plurality of standard questions meeting preset conditions is determined as candidate standard questions according to the text similarity.

Specifically, the preset condition may be a text similarity threshold, and a standard question of the plurality of preset standard questions with a text similarity higher than the text similarity threshold is taken as a candidate standard question, or that the plurality of standard questions of the plurality of preset standard questions having the text similarity with the to-be-answered question ranked at the top are selected as candidate standard questions. For example, the plurality of standard questions having the text similarity with the to-be-answered question ranked at the top 5, the top 10, or the top 15 may be all possible, which may be specifically set according to actual requirements.

In some embodiments, the number of candidate standard questions is in a range of 5 to 15.

Specifically, the number of candidate standard questions may be determined as needed, for example, in a range of 5 to 15, and for example, 10.

In some embodiments, the step (Step S103) specifically includes the following steps.

(1) a word segmentation is performed on the to-be-answered question to obtain n words to be processed, where n is an integer greater than or equal to 1.

Since the “word” subsequently needs to be compared with the text, the to-be-answered question needs to be firstly divided (segmented) into n words (words to be processed) for the subsequent process.

The word segmentation process may be implemented by using a known word segmentation tool, and is not described in detail herein.

In some embodiments, this step may include: performing the word segmentation on the to-be-answered question, removing preset excluded words in the obtained words, and taking the remaining n words as the words to be processed.

In the to-be-answered question, some words are not substantial, such as some adverbs, and modal particles (such as “of”), so it is preferable that these words are not subjected to the subsequent processing to reduce the computation amount. For this purpose, a word list of “excluded words” may be set in advance. Words obtained from the to-be-answered question are deleted if they belong to the excluded words, and are not used as the to-be-processed word.

(2) The text similarity between each to-be-processed word and each standard question is determined.

The text similarity between the i-th to-be-processed word and the standard question d is TF-IDF_{(i,d)}=TF_{(i,d)}*IFDᵢ, TF_{(i,d)}=(the number of the i-th to-be-processed word in the standard question d/the total number of words in the standard question d), IFDᵢ=lg[the total number of standard questions/(the number of standard questions including the i-th to-be-processed word+1)].

The above algorithm may calculate the relevance of each word to each text in a text library, i.e. the text similarity. In the embodiment of the present disclosure, each standard question is taken as one “text”, and all standard questions constitute the “text library”.

Specifically, the text similarity TF-IDF_{(i,d)} between the i-th to-be-processed word and the standard question d is obtained by multiplying a first sub-similarity TF_{(i,d)} and a second sub-similarity IFDᵢ.

The first sub-similarity TF_{(i,d)}=(the number of the i-th to-be-processed word in the standard question d/the total number of words in the standard question d), that is, the first sub-similarity TF_{(i,d)} represents the “frequency” of occurrences of the word (to-be-processed word) in the text (standard question), which represents the degree of correlation between the word and the text in the case that the influence of the length of the text is eliminated.

The second sub-similarity IFDᵢ=lg[the total number of standard questions/(the number of standard questions containing the i-th to-be-processed word+1)], which means that the more texts (standard questions) in the text library (all standard questions) that the word (to-be-processed word) appears in, the lower the second sub-similarity IFDᵢ is.

It may be seen that the word appearing in many texts is often a “common word (such as “of”)”, but has no practical meaning, and therefore, the influence of the “common word” can be eliminated by the above second sub-similarity IFDᵢ.

Therefore, the text similarity obtained by multiplying the first sub-similarity and the second sub-similarity may indicate the correlation degree between the to-be-processed word and the standard question most accurately.

(3) The text similarity between each standard question and the to-be-answered question is determined.

The text similarity between each standard question and the to-be-answered question is S_{d}=Σᵢ₌₁ⁱ⁼ⁿTF-IDF_{(i,d)}.

As before, the to-be-answered question includes n to-be-processed words, so the text similarity between the to-be-answered question and the standard question should be the sum of the degrees of relevance between all the to-be-processed words and the standard question, that is, the sum of the text similarities of all the to-be-processed words with the standard question. Thus, the text similarity between the standard question d and the to-be-answered question is S_{d}=Σᵢ₌₁ⁱ⁼ⁿTF−IDF_{(i,d)}.

(4) A plurality of standard questions meeting a preset condition are determined as candidate standard questions according to the text similarity between each standard questions with the to-be-answered question.

After the text similarity between each standard question and the to-be-answered question is determined, the plurality of standard questions meeting preset conditions are determined as candidate standard questions according to the text similarity.

Specifically, the preset condition may be text similarity threshold as set, and a standard question of the plurality of preset standard questions with a text similarity higher than the text similarity threshold is taken as a candidate standard question, or the standard questions of the plurality of preset standard questions having the text similarity with the to-be-answered question ranked at the top are selected as candidate standard questions. For example, the standard questions having the text similarity with the to-be-answered question ranked at the top 5, the top 10, or the top 15 may be all possible, which may be specifically set according to actual requirements.

In some embodiments, before determining the text similarity between each to-be-processed word and each standard question, the method further includes: calculating and storing the text similarity between a plurality of preset words and each standard question, wherein the plurality of preset words are words included in the standard questions.

Determining the text similarity between each to-be-processed word and each standard question includes: when the to-be-processed word is one of the stored preset words, taking the text similarity between the one of the stored preset words and each standard question as the text similarity between the to-be-processed word and each standard question.

As before, the text similarity between the to-be-answered question and each standard question is actually determined by the text similarity between each “word (to-be-processed word)” and each standard question.

Therefore, the word segmentation may be performed on each standard question in advance, part or all of the words are used as preset words, the text similarity between the preset words and each standard question is calculated in advance, and the result (namely the correspondence among the preset words and the standard question and the text similarity) is stored and used as an index.

Therefore, when the text similarity between the to-be-processed word and the standard question is determined in the subsequent process, whether each to-be-processed word is one of the pre-stored preset words or not may be determined. If yes (namely, the to-be-processed word belongs to the preset word), the text similarity of the to-be-processed word (the preset word) with each standard question may be directly obtained by querying the index without actually calculating the text similarity, and therefore the calculation amount required in the text similarity calculation is saved.

In some embodiments, each standard question is used to query a value of a standard attribute of a standard entity;

The standard entity in the standard question is represented by the type label corresponding to the type thereof.

As a way of an embodiment of the present disclosure, the “intention” of each standard question is to query the value of the standard attribute of the standard entity.

For example, the standard question “when Mona Lisa was authored” is for querying the “authoring time” attribute (standard attribute) of the entity (standard entity) “Mona Lisa”.

Of course, there may be multiple entities present in each standard question, but only the entity corresponding to the standard attribute that needs to be queried is the standard entity. The specific standard entity in the standard question and the standard attribute thereof may be preset when the standard question is set.

Obviously, the standard entity in the standard question may be a specific entity (such as “Mona Lisa”), but the number of such standard questions is very large due to the large number of specific entities. To reduce the number of standard questions, the standard questions may be in the form of a “template”, i.e., the standard entities in the standard questions are in the form of the “type label”. Thus, the “intention” of the standard question in the form of the “template” is not to query a standard attribute of one “specific entity”, but a standard attribute of a “one class of entities”.

For example, the above standard question of “when Mona Lisa was authored” may be specifically when ZP was authored; or when was authored.

The above “ZP” and “a” are both type labels of “work” type, so the above standard question is used to query “authoring time” attribute (standard attribute) of the entity (standard entity) of the “work” type.

Step S104 includes determining a candidate standard question from a plurality of candidate standard questions with the highest semantic similarity with the to-be-answered question as a matching standard question based on a deep learning text matching model.

After the plurality of candidate standard questions are obtained, the candidate standard questions and the to-be-answered question are input into a preset deep learning text matching model to obtain semantic similarity (namely a similarity on the semantic) of each candidate standard question output by the deep learning text matching model with the to-be-answered question, so that the candidate standard question with the highest semantic similarity with the to-be-answered question is determined as the matching standard question. That is, the matching standard question with the same intention as the to-be-answered question is determined, and answer of the to-be-answered question may be obtained according to the matching standard question subsequently.

For example, for the above to-be-answered question of “which year the Last Supper of DaVinci was authored”, the matching standard question as determined may be “when Mona Lisa was authored”.

In some embodiments, the deep learning text matching model is configured as follows.

A bidirectional encoder representations from transformers model is used to obtain a text representation vector of the to-be-answered question, a text representation vector of the standard question and interactive information of the text representation vector of the to-be-answered question and the text representation vector of the standard question according to the to-be-answered question and the standard question.

Global max pool is performed on the text representation vector of the to-be-answered question and the text representation vector of the standard question, respectively, and global average pool perform on the text representation vector of the to-be-answered question and the text representation vector of the standard question, respectively.

The interactive information, a difference between a result of the global max pool of the text representation vector of the to-be-answered question and a result of the global max pool of the text representation vector of the standard question and a difference between a result of the global average pool of the text representation vector of the to-be-answered question and a result of the global average pool of the text representation vector of the standard question are input into a full connection layer, to obtain the semantic similarity between the to-be-answered question and the standard question.

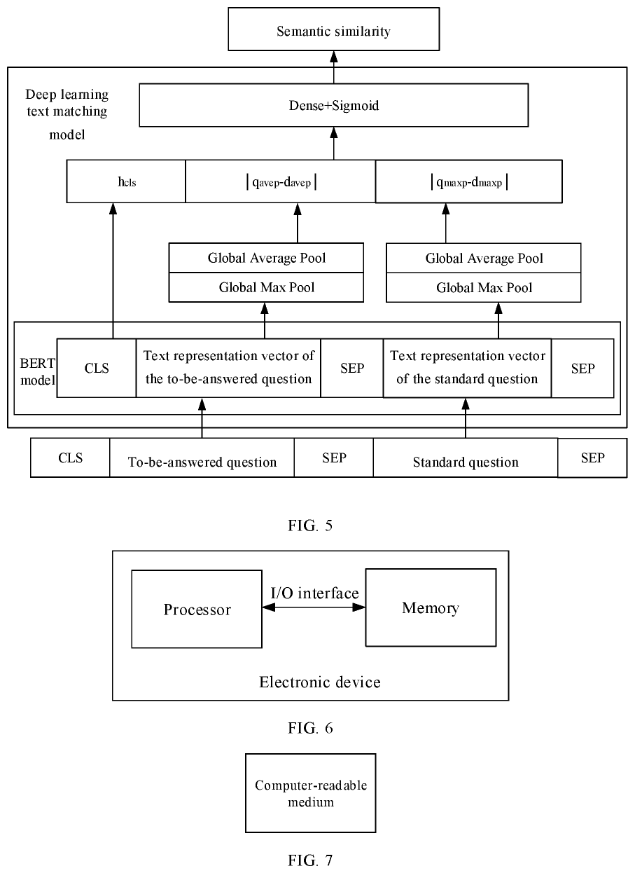

For example, referring to FIG. 5, the deep learning text matching model in the embodiment of the present disclosure may utilize a bidirectional encoder representations from transformers model (BERT model), which performs word embedding on input texts (the to-be-answered question and the candidate standard question) to represent the input texts in a form of h₀, and then obtains a text representation vector h_{L} by applying h₀ into a transformer network of L layers, where CLS is a mark symbol of the text processed in the BERT model, SEP is a separator between different texts (the to-be-answered question and the candidate standard question);

h₀=XWₜ+Wₛ+Wₚ

hᵢ=Transformer(hᵢ₋₁), i∈[1,L].

where X represents a word sequence obtained by performing the word segmentation on the input text (the to-be-answered question and the candidate standard question), Wₜ is a word embedding matrix, Wₚ is a position embedding matrix and Wₛ is a sentence embedding matrix, and Transformer ( ) represents that a Transformer network carries out one-layer processing on the content in brackets; hᵢ represents an output of the i-th layer of the Transformer network, so that hᵢ is an output of a hidden layer of the Transformer network when i is not equal to L; and hᵢ is h_{L} when i is L, that is, h_{L} is a text representation vector finally output by the Transformer network.

The text representation vector of the to-be-answered question and the text representation vector of the candidate standard question output by the BERT model are denoted below by q and d, respectively.

In order to obtain the semantic similarity between the to-be-answered question and the candidate standard question, the interactive information and the difference information between q and d are required, the information on q and d are spliced together to obtain h_{qd}, which is sent to a full connection layer (such as a Dense layer) to carry out binary classification (such as Sigmoid function classification).

Dense is a function, which is a specific implementation of the full connection layer, and the calculation formula for the Dense is as follows:

Out=Activation(Wx+bias);

where x is the input to the function, which is an n-dimensional vector; W is a preset weight in the form of an m×n dimensional vector; Activation represents an activation function; bias represents a preset bias; Out is an output of the function, which is an m-dimensional vector.

Specifically, the interactive information h_{c1s} is output by the BERT model, specifically, the interactive information is output after a final hidden state corresponding to the mark symbol CLS in the BERT model is pooled, that is, the interactive information is the result after the output of an (L−1)th layer of the Transformer network is pooled, which may represent the correlation (not the semantic similarity) between q and d (or the to-be-answered question and the candidate standard question) to some extent.

The difference information is obtained by: performing the global max pool and the global average pool on q and d, respectively, and deriving the difference between the results of global average pool and the difference between the results of global max pool as the difference information, respectively.

The results of global max pool and the results of global average pool of q and d are as follows:

qₐᵥₑₚ=GlobalAveragePool(q); qₘₐₓₚ=GlobalMaxPool(q);

dₐᵥₑₚ=GlobalAveragePool(d); dₘₐₓₚ=GlobalMaxPool(d);

Thus, qₐᵥₑₚ−dₐᵥₑₚ represents the difference between the results of global average pool (hereinafter, global average pool results) of q and d; qₘₐₓₚ−dₘₐₓₚ represents the difference between the results of global max pool (hereinafter, global max pool results) of q and d, such two differences are the difference information; the difference information may represent the difference between q and d (or the to-be-answered question and the candidate standard question) (not the direct difference between q and d in text) to some extent.

Thus, the result h_{qd} by splicing the interactive information h_{c1s} and the difference information (hereinafter, splicing result) may be expressed as:

h_{qd}=Concatenate([h_{c1s},|qₐᵥₑₚ−dₐᵥₑₚ|,|qₘₐₓₚ−dₘₐₓₚ|];

where Concatenate represents the splice, h_{c1s} is the interactive information, qₐᵥₑₚ−dₐᵥₑₚ and qₘₐₓₚ−dₘₐₓₚ are the difference information;

where q and d are text feature vectors, which are each a vector having a shape [B, L, H], where B is a batch size (a size of the data processed at each time), L represents a length of the text (the to-be-answered question and the candidate standard question), and H represents a dimension of the hidden layer.

The global average pool is performed by averaging a vector in the second dimension, so that a global average pool result for a vector with a shape of [1, L, H] is a vector with a shape of [1, H], and a global average pool result for a vector with a shape of [B, L, H] is a vector with a shape of [B, H]. Similarly, the global max pool is performed by taking the maximum of a vector in the second dimension, so that a processing result for a vector with a shape of [B, L, H] is also a vector with a shape of [B, H]. Furthermore, the difference information (the difference qₐᵥₑₚ−dₐᵥₑₚ between the global average pool results and the difference qₘₐₓₚ−dₘₐₓₚ between the global max pool results) is also a vector having the shape of [B, H].

As before, the interactive information is a vector represented by a sample (text) marked by [CLS], so a shape of the interactive information is also [B, H].

The splice above refers to directly splicing a vector of the interactive information h_{c1s} and the two vectors qₐᵥₑₚ−dₐᵥₑₚ and qₘₐₓₚ−dₘₐₓₚ corresponding to the difference information in the first dimension, so that the splicing result h_{qd} is a vector with a shape of [B, 3×H].

After the splicing result h_{qd} of the interactive information and the difference information is determined, the splicing result h_{qd} is further classified by using a Sigmoid function so as to output the semantic similarity \tilde{y} between the candidate standard question and the to-be-answered question:

\tilde{y}=Sigmoid(Wh_{qd}+b)

where W is a parameter matrix obtained by training, WΣR^{K×H}; where K is the number of labels to be classified, here, the label is 0 (indicating a matching result without similarity) or 1 (indicating a matching result with similarity), i.e., K=2; b is a bias; R represents a real number space; H represents a dimension of the hidden layer of the neural network.

Of course, in addition to the above form, the deep learning text matching model adopted in the embodiment of the present disclosure may also be other deep learning text matching models, such as a representation-based model, an interaction-based model, or the like.

Of course, the deep learning text matching model (such as the deep learning text matching model that implements the specific process of the above Step S104) may be obtained by training in advance.

The training process may be: inputting a training sample (a preset to-be-answered question and a candidate standard question) with a preset result (the semantic similarity) into the deep learning text matching model, comparing the result output by the deep learning text matching model with the preset result, and determining how to adjust each parameter in the deep learning text matching model through a loss function.

A cross entropy loss function may be used as a target function (a loss function) loss during training the deep learning text matching model:

loss=−[y log(\tilde{y})+(1−y)log(1−\tilde{y})]

where y is a label of a training sample (i.e., the preset result); \tilde{y} is a prediction label for the model (i.e., the result output by the model). Therefore, a combined fine adjustment may be performed on all the parameters in the parameter matrix W according to loss, and a logarithmic probability of a correct result is maximized, that is, loss is minimized.

Step S105 includes determining a question entity corresponding to the standard entity of the matching standard question as a matching question entity, and determining a value of a standard attribute of the matching question entity in the knowledge mapping as an answer.

As before, the matching standard question is for querying the “standard attribute” of the “standard entity” therein. The to-be-answered question has the same “intention” as that of the matching standard question, so that the to-be-answered question is necessarily for querying the “standard attribute” of a certain “question entity” therein.

Therefore, as long as the question entity (the matching question entity) of the to-be-answered question corresponding to the standard entity of the matching standard question is determined, it is determined that the to-be-answered question is for querying the “standard attribute” of the “matching question entity”, so that the value of the “standard attribute” of the “matching question entity” may be found from the knowledge mapping as the answer to the to-be-answered question.

For example, the matching standard question “when Mona Lisa was authored” queries the standard attribute “authoring time” of the standard entity “Mona Lisa”. If “the Last Supper” in the to-be-answered question “which year the Last Supper of DaVinci was authored” is determined to be the matching standard entity, the value of the standard attribute “authoring time” of the matching standard entity “the Last Supper” may be searched in the preset knowledge mapping, and the result of “in 1498” is output.

In some embodiments, determining a question entity corresponding to the standard entity of the matching standard question as a matching question entity includes: determining the question entity having the same type label as that of the standard entity of the matching standard question as the matching question entity.

As before, when the standard entity in the matching standard question is in the form of a type label, the question entity having the same type label as that of the standard entity from the question entity of the to-be-answered question may be determined to be the matching question entity.

For example, in the matching standard question “when ZP was authored”, the type label of the standard entity is ZP (work); the to-be-answered question “which year the Last Supper of DaVinci was authored” includes two question entities “DaVinci” and “the Last Supper”, with type labels “RW (person)” and “ZP (work)”, respectively; the type label of the question entity “the Last Supper” is ZP (work), which is the same as that of the standard entity, so that “the Last Supper” may be determined to be the matching question entity. Further, the answer may be determined to be the value of the “authoring time” attribute (the standard attribute) of “the Last Supper” entity (the matching question entity) in the knowledge mapping, that is, the value is “in 1498”.

That is, it may be determined what the to-be-answered question asks, through the standard attribute of the matching standard question, and, it may be determined what the to-be-answered question is about, through the matching question entity of the to-be-answered question, which are combined with each other so that it may be determined what the to-be-answered question asks and what the to-be-answered question is about, and accordingly, an accurate answer is obtained from the knowledge mapping.

In a second aspect, referring to FIG. 6, an embodiment of the present disclosure provides an electronic device, including: one or more processors; a memory on which one or more programs are stored, when executed by the one or more processors, the one or more programs cause the one or more processors to implement the question-and-answer processing method of any one of the above embodiments; and one or more I/O interfaces coupled between the processor and the memory and configured to realize an information interaction between the processor and the memory.

The processor is a device with data processing capability, which includes, but is not limited to, a central processing unit (CPU) and the like; the memory is a device with data storage capability including, but not limited to, random access memory (RAM, more specifically, SDRAM, DDR, etc.), read only memory (ROM), electrically erasable programmable read only memory (EEPROM), flash memory (FLASH); the I/O interface (read/write interface) is coupled between the processor and the memory, and may realize information interaction between the memory and the processor, and includes, but is not limited to, a data bus (Bus) and the like.

In a third aspect, with reference to FIG. 7, an embodiment of the present disclosure provides a computer-readable medium, on which a computer program is stored, wherein the program is executed by a processor to implement the question-and-answer processing method in any one of the above embodiments.

One of ordinary skill in the art will appreciate that all or some of the steps, systems, functional modules/units in the devices disclosed above may be implemented as software, firmware, hardware, and suitable combinations thereof.

In a hardware implementation, a division between functional modules/units mentioned in the above description does not necessarily correspond to a division for physical components. For example, one physical component may have multiple functions, or one function or step may be performed by several physical components in cooperation.

Some or all of the physical components may be implemented as software executed by a processor, such as a central processing unit (CPU), a digital signal processor, or a microprocessor, or as hardware, or as an integrated circuit, such as an application specific integrated circuit. Such software may be distributed on a computer readable medium, which may include a computer storage medium (or non-transitory medium) and a communication medium (or transitory medium). The term “computer storage medium” includes volatile and nonvolatile, removable and non-removable medium implemented in any method or technology for storage of information such as computer readable instructions, data structures, program modules or other data, as is well known to one of ordinary skill in the art. The computer storage medium includes, but is not limited to, random access memory (RAM, more specifically, SDRAM, DDR, etc.), read only memory (ROM), electrically erasable programmable read only memory (EEPROM), flash memory (FLASH), or other disk storage; compact disk read only memory (CD-ROM), digital versatile disk (DVD), or other optical disk storage; magnetic cassettes, magnetic tape, magnetic disk storage or other magnetic storage; any other medium which may be used to store the desired information and which may be accessed by a computer. In addition, the communication medium typically embodies computer readable instructions, data structures, program modules or other data in a modulated data signal such as a carrier wave or other transport mechanism and includes any information delivery medium, as is well known to one of ordinary skill in the art.

The present disclosure has disclosed example embodiments, and although specific terms are employed, they are used and should be interpreted in a generic and descriptive sense only and not for purposes of limitation. In some instances, features, characteristics and/or elements described in connection with a particular embodiment may be used alone or in combination with features, characteristics and/or elements described in connection with other embodiments, unless expressly stated otherwise, as would be apparent to one of ordinary skill in the art. It will, therefore, be understood by one of ordinary skill in the art that various changes in form and details may be made therein without departing from the scope of the present disclosure as set forth in the appended claims.

1. A question-and-answer processing method, comprising:
acquiring a to-be-answered question;
determining standard questions meeting a preset condition as a plurality of candidate standard questions, from a plurality of preset standard questions, according to a text similarity with the to-be-answered question, based on a text statistical algorithm;
determining, a candidate standard question with the highest semantic similarity with the to-be-answered question as a matching standard question, from the plurality of candidate standard questions, based on a deep text matching algorithm; and
determining an answer to the to-be-answered question at least according to the matching standard question.

2. The method of claim 1, wherein,
the deep text matching algorithm is a preset deep learning text matching model; the deep learning text matching model is configured to:
use a bidirectional encoder representations from transformers model to obtain a text representation vector of the to-be-answered question, a text representation vector of the standard question and interactive information between the text representation vector of the to-be-answered question and the text representation vector of the standard question according to the to-be-answered question and the standard question;
perform a global max pool on the text representation vector of the to-be-answered question and the text representation vector of the standard question, respectively, and perform a global average pool on the text representation vector of the to-be-answered question and the text representation vector of the standard question, respectively; and
input the interactive information, a difference between a result of the global max pool of the text representation vector of the to-be-answered question and a result of the global max pool of the text representation vector of the standard question, and a difference between a result of the global average pool of the text representation vector of the to-be-answered question and a result of the global average pool of the text representation vector of the standard question into a full connection layer, to obtain a semantic similarity between the to-be-answered question and the standard question.

3. The method of claim 1, wherein,
the determining an answer to the to-be-answered question at least according to the matching standard question comprises: determining the answer to the to-be-answered question from a preset knowledge mapping at least according to the matching standard question;
each of the standard questions is configured to query a value of a standard attribute of a standard entity;
the method further comprises, after the acquiring a to-be-answered question and before the determining the standard questions meeting a preset condition as a plurality of candidate standard questions, determining an entity of the to-be-answered question belonging to the knowledge mapping as a question entity; and
the determining the answer to the to-be-answered question from a preset knowledge mapping at least according to the matching standard question comprises: determining a question entity corresponding to the standard entity of the matching standard question as a matching question entity, and determining a value of a standard attribute of the matching question entity in the knowledge mapping as an answer.

4. The method of claim 3, wherein,
the standard entity of the standard question is represented by a type label corresponding to a type of the standard entity; and
the determining an entity of the to-be-answered question belonging to the knowledge mapping as a question entity comprises: determining the entity of the to-be-answered question belonging to the knowledge mapping as the question entity, and replacing the question entity in the to-be-answered question with a type label corresponding to a type of the question entity.

5. The method of claim 4, wherein the determining a question entity corresponding to the standard entity of the matching standard question as a matching question entity comprises:
determining the question entity having the same type label as that of the standard entity of the matching standard question as the matching question entity.

6. The method of claim 1, wherein the determining standard questions meeting a preset condition as a plurality of candidate standard questions comprises:
performing a word segmentation on the to-be-answered question to obtain n to-be-processed words, where n is an integer greater than or equal to 1;
determining the text similarity between each to-be-processed word and each standard question, wherein the text similarity between an i-th to-be-processed word and the standard question d is TF-IDF_{(i,d)}=TF_{(i,d)}*IFDᵢ, TF_{(i,d)}=(a number of the i-th to-be-processed word in the standard question d/a total number of words in the standard question d), IFDᵢ=lg[a total number of the standard questions/(a number of the standard questions comprising the i-th to-be-processed word+1)];
determining the text similarity between each standard question and the to-be-answered question, wherein the text similarity between each standard question and the to-be-answered question is S_{d}=Σᵢ₌₁ⁱ⁼ⁿTF-IDF_{(id)}; and
determining a plurality of standard questions meeting the preset condition as candidate standard questions according to the text similarity between each standard question and the to-be-answered question.

7. The method of claim 6, wherein the performing a word segmentation on the to-be-answered question to obtain n to-be-processed words comprises:
performing the word segmentation on the to-be-answered question to obtain words, removing preset excluded words from the obtained words, and taking the remaining n words as the to-be-processed words.

8. The method of claim 6, wherein,
the method further comprises before the determining the text similarity between each to-be-processed word and each standard question, calculating and storing the text similarity between a plurality of preset words and each standard question, wherein the plurality of preset words are words comprised in the standard questions; and
the determining the text similarity between each to-be-processed word and each standard question comprises: in a case where the to-be-processed word is one of the stored preset words, taking the text similarity between the one of the stored preset words and each standard question as the text similarity between the to-be-processed word and each standard question.

9. The method of claim 1, wherein,
a number of the plurality of candidate standard questions is between 5 and 15.

10. An electronic device, comprising:
one or more processors;
a memory on which one or more programs are stored, when executed by the one or more processors, the one or more programs cause the one or more processors to implement the question-and-answer processing method of claim 1; and
one or more I/O interfaces coupled between the processor and the memory and configured to realize an information interaction between the processor and the memory.

11. A non-transitory computer-readable storage medium, on which a computer program is stored, wherein the computer program, when executed by a processor, implements the question-and-answer processing method of claim 1.

12. The electronic device of claim 11, wherein,
the deep text matching algorithm is a preset deep learning text matching model; the deep learning text matching model is configured to:
use a bidirectional encoder representations from transformers model to obtain a text representation vector of the to-be-answered question, a text representation vector of the standard question and interactive information between the text representation vector of the to-be-answered question and the text representation vector of the standard question according to the to-be-answered question and the standard question;
perform a global max pool on the text representation vector of the to-be-answered question and the text representation vector of the standard question, respectively, and perform a global average pool on the text representation vector of the to-be-answered question and the text representation vector of the standard question, respectively; and
input the interactive information, a difference between a result of the global max pool of the text representation vector of the to-be-answered question and a result of the global max pool of the text representation vector of the standard question, and a difference between a result of the global average pool of the text representation vector of the to-be-answered question and a result of the global average pool of the text representation vector of the standard question into a full connection layer, to obtain a semantic similarity between the to-be-answered question and the standard question.

13. The electronic device of claim 11, wherein,
the processor is further configured to determine the answer to the to-be-answered question from a preset knowledge mapping at least according to the matching standard question, and
wherein each of the standard questions is configured to query a value of a standard attribute of a standard entity.

14. The electronic device of claim 13, wherein,
the processor is further configured to determine an entity of the to-be-answered question belonging to the knowledge mapping as a question entity.

15. The electronic device of claim 14, wherein,
the processor is further configured to determine a question entity corresponding to the standard entity of the matching standard question as a matching question entity, and determine a value of a standard attribute of the matching question entity in the knowledge mapping as an answer.

16. The electronic device of claim 15, wherein,
the standard entity of the standard question is represented by a type label corresponding to a type of the standard entity; and
the processor is further configured to determine the entity of the to-be-answered question belonging to the knowledge mapping as the question entity, and replace the question entity in the to-be-answered question with a type label corresponding to a type of the question entity.

17. The electronic device of claim 16, wherein,
the processor is further configured to determine the question entity having the same type label as that of the standard entity of the matching standard question as the matching question entity.

18. A non-transitory computer-readable storage medium, on which a computer program is stored, wherein the computer program, when executed by a processor, implements the question-and-answer processing method of claim 2.

19. A non-transitory computer-readable storage medium, on which a computer program is stored, wherein the computer program, when executed by a processor, implements the question-and-answer processing method of claim 3.

20. A non-transitory computer-readable storage medium, on which a computer program is stored, wherein the computer program, when executed by a processor, implements the question-and-answer processing method of claim 4.
